(19) United States
(12) Patent Application Publication
(10) Pub. No.: US 2024/0273485 A1
(43) Pub. Date: Aug. 15, 2024

(54) SYSTEMS AND METHODS FOR COMPLETING AN INTERACTION AT A PARTICULAR TIME DETERMINED BY A USER

(71) Applicant: Truist Bank, Charlotte, NC (US)

(72) Inventor: Prasad Prabhakarrao Jahagirdar, Fort Mill, SC (US)

(73) Assignee: Truist Bank, Charlotte, NC (US)

(21) Appl. No.: 18/168,170

(22) Filed: Feb. 13, 2023

(51) Int. Cl. G06Q 20/08; G06Q 20/40

(52) U.S. Cl. CPC G06Q 20/0855; G06Q 20/4014

(57) ABSTRACT

A system is disclosed for completing an interaction at a particular time by establishing a user communication connection with a user device associated with a user, where the communication connection includes generating and displaying a user interaction interface on the user device. Through the user communication connection, the system receives identifying information associated with the user and determines whether the identifying information is authentic. The system then receives a scheduled interaction from the user that includes a specific time for the scheduled interaction to occur. After establishing a third party communication connection with a third party user device associated with a third party, the system completes the scheduled interaction between the user and the third party at the specified time.

### FIELD

This invention generally relates to the art of generating and completing an interaction at a specified time, based upon instructions received from a user.

### BACKGROUND

There are instances where a user may want to not only make a payment on a particular day, but may also need for the payment to be made at a particular time for any number of varying reasons. Accordingly, a need exists for systems and methods for allowing a customer or user to schedule a transfer of funds from their account to a third party account at a specified time, rather than having to make the payment in real time.

### BRIEF SUMMARY

Embodiments of the present invention address the above needs and/or achieve other advantages by providing systems and methods to ensure users remain content with their user experience and are able to easily navigate the system without having to learn a new system.

According to example embodiments of the invention, a system for completing an interaction at a specified time, where the system includes at least one processor, a communication interface communicatively coupled to the at least one processor and configured to communicate over at least one network with one or more additional sets of processors, and a memory device storing executable code that, when executed, causes the processor to perform a series of functions including, establishing a user communication with a user device associated with a user, wherein establishing the communication connection includes generating and displaying a user interaction interface on the user device. The system receives, via the established user communication connection, identifying information associated with the user from the user device. In response to receiving the identifying information associated with the user, the system determines whether the identifying information is authentic. The system then receives a scheduled interaction from the user, wherein the scheduled interaction includes a particular time for the scheduled interaction to occur. After establishing a third party communication connection with a third party user device associated with a third party, the system completes the scheduled interaction between the user and the third party at the particular time.

According to particular embodiments, a method is disclosed for completing an interaction at a specified time. The method includes (1) establishing a user communication connection with a user device associated with a user, wherein establishing the communication connection includes generating and displaying a user interaction interface on the user device; (2) receiving, via the established user communication connection, identifying information associated with the user from the user device; (3) in response to receiving the identifying information, determining whether the identifying information is authentic; (4) receiving a scheduled interaction from a user, wherein the scheduled interaction includes a particular time for the scheduled interaction to occur; (5) establishing a third party communication connection with a third part user device associated with a third part; and (6) completing the scheduled interaction between the user and the third party at the particular time.

Embodiments of the invention include a system for completing an interaction at a preselected time, where the system includes at least one processor, a communication interface communicatively coupled to the at least one processor and configured to communicate over at least one network with one or more additional sets of processors, and a memory device storing executable code that, when executed, causes the processor to perform a series of functions including, establishing a user communication connection with a user device associated with a user, wherein establishing the user communication connection includes generating and displaying a user interaction interface on the user device. The system receives, via the established user communication connection, identifying information associated with the user from the user device. In response to receiving the identifying information associated with the user, the system determines whether the identifying information is authentic. The system then receives at a first time a scheduled interaction from the user, wherein the scheduled interaction includes an indication for the scheduled interaction to occur at a second time. After establishing a third party communication connection with a third party user device associated with a third party, the system completes the scheduled interaction between the user and the third party at the second time.

The features, functions, and advantages that have been discussed may be achieved independently in various embodiments of the present invention or may be combined in yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an enterprise system and environment thereof for dynamically assigning a predetermined user experience to display in a graphical user interface, in accordance with an embodiment of the present invention.

FIG. 2A is a flowchart illustrating a method for generating an automated alert to complete an interaction, according to at least one embodiment.

FIG. 2B is a continuation of the flowchart of FIG. 2A illustrating a method for generating an automated alert to complete an interaction, according to at least one embodiment.

FIG. 3A is a flowchart illustrating a method for prefilling interaction instructions based on the user's instructions or from various patterns instituted by the user, according to at least one embodiment.

FIG. 3B is a continuation of the flowchart of FIG. 3A illustrating a method for prefilling interaction instructions based on the user's instructions or from various patterns instituted by the user, according to at least one embodiment.

FIG. 4 is a flowchart illustrating a method for completing an interaction at a particular time determined by a user, according to at least one embodiment.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

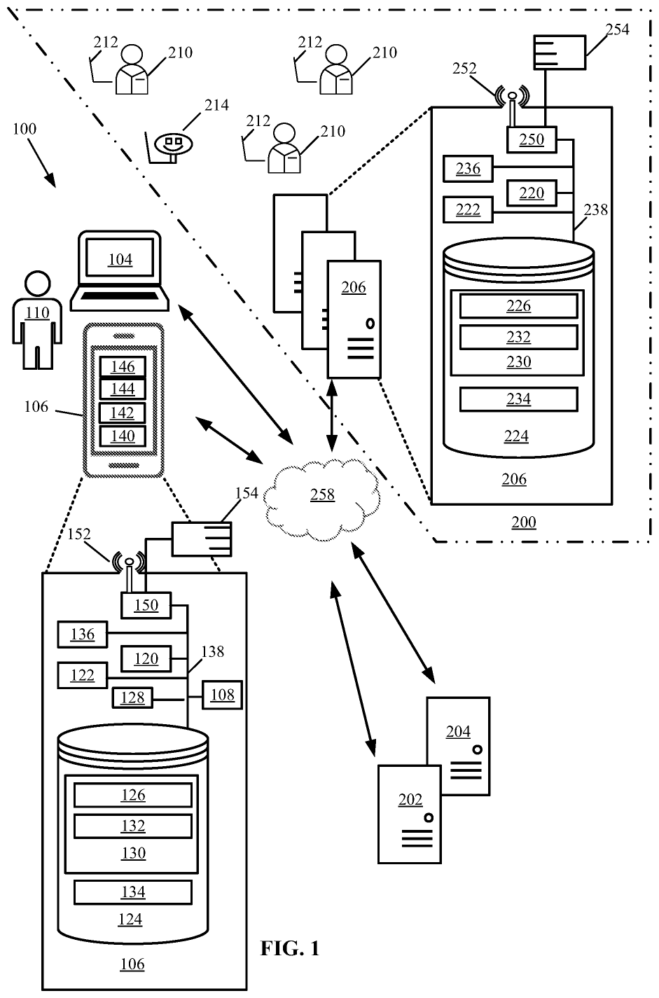

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be, for example, a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, a contactless communication device, and other transceivers. In addition, GPS (Global Positioning System) may be included for navigation and location-related data exchanges, ingoing and/or outgoing. Communications may also or alternatively be conducted via the connector 154 for wired connections such as by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may be utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210, can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the mobile device 104 and computing device 106, the agent devices 212, the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

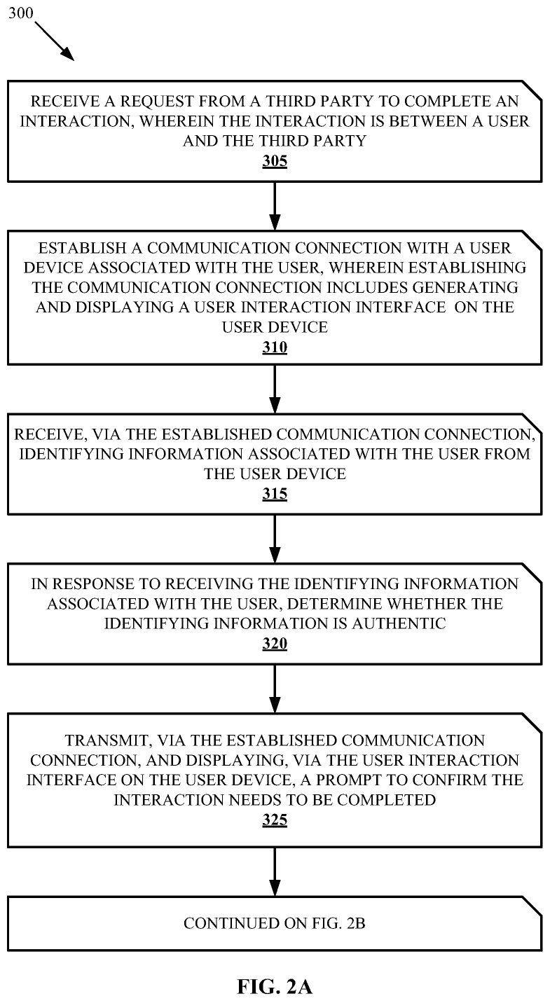

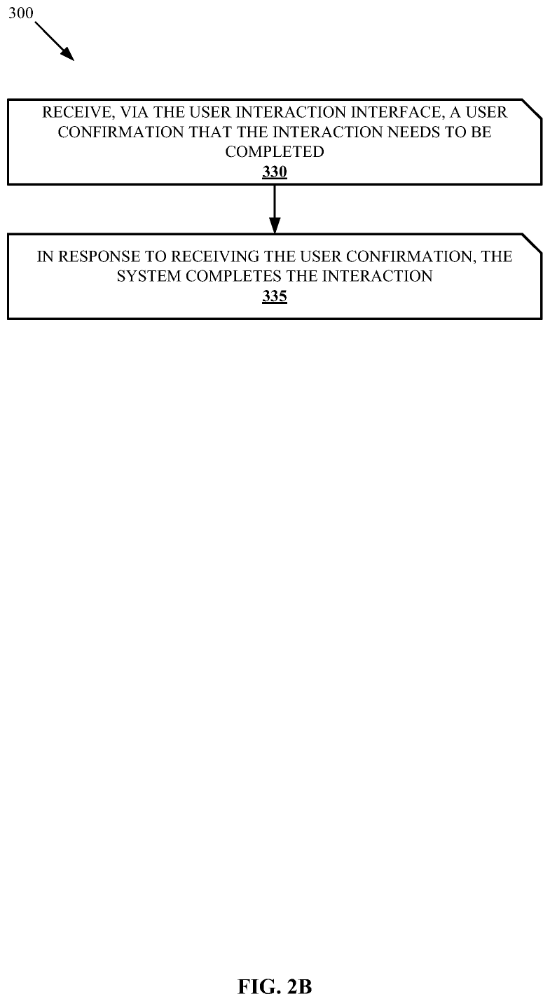

FIGS. 2A-2B depict a flow chart representing a system and method 300, according to at least one embodiment, for completing an interaction in response to sending an alert or prompt to a user. The method 300 is performed by a system that includes at least one processor, a communication interface communicatively coupled to the at least one processor and configured to communicate over at least one network with one or more additional sets of processors, and a memory device storing executable code, that when executed, causes the processor to perform a series of events. In particular embodiments, the system sends out a notification or prompt to a user that a payment is due. From the notification, the user may select to complete the interaction and make the payment, select to not complete the interaction, or simply ignore the alert/prompt, thereby not completing the requested interaction.

The first step, as represented by block 305, is to receive a request from a third party to complete an interaction, where the interaction is between a user and the third party. The request may be received from a web-based browser or a dedicated application associated with an entity or person with which the user may or may not have an affiliation or relationship. In particular embodiments, the requested interaction may be a request to pay a bill, submit an ACH transaction, or to complete an electronic fund transfer. In example embodiments, the request may include additional information such as who is making the request, where the request is coming from, the amount being requested, the reason for the request, a date when the requested interaction is due, and other similar details.

In example embodiments, the third party may be another bank or financial institution, a business, or a private individual. For example, the third party may be an auto financing company that the user has an auto loan with that requires monthly payments. In other embodiments, the third party may be a credit card company that the user has one or more accounts with, which would also require a monthly payment, typically on the same day of the month for each payment. Other examples of requests received from third parties may come from an entity or an individual through a banking application such as Zelle® or Venmo® or any other electronic fund transfer application or financial service.

The next step, as represented by block 310, is to establish a communication tunnel or connection with a user device associated with the user, wherein establishing the communication tunnel includes generating and displaying a user interaction interface on the user device. In example embodiments, the system is configured to communicate with the user device via SMS, text, email, and/or app push notification.

The next step, as represented by block 315, is to receive identifying information associated with the user from the user device via the established communication tunnel or connection. The system may receive the information directly from the user via a web-based browser or dedicated application. In other embodiments, the system may store the identifying information associated with the user from prior interactions with the user. In example embodiments, the user identifying information includes any one or more identifiers associated with the user such as the user's: (1) name; (2) phone number; (3) account number(s); (4) code number or identifier indicating which entity the user is a client or customer with; and/or (5) other profile data.

The next step, as represented by block 320, is to determine whether the identifying information is authentic in response to receiving the identifying information associated with the user. In some embodiments, the user may need to login to the web-based browser or dedicated application using basic credentials such as a username and password in order for the system to authenticate the user. In particular embodiments, more advanced credentials may be required such as biometric data, a personal identification number, and/or a two-step verification protocol for allowing the user to log in. In example embodiments, the system generates a unique code that is transmitted either to the user device or to another device associated with the user. The unique code is then displayed on the device for the user to view and to enter into the system in order for the system to determine that the identifying information is authentic.

The next step, as represented by block 325, is to transmit, via the established communication tunnel/connection, and display, via the user interaction interface on the user device, a prompt to confirm that the interaction needs to be completed. The prompt may be transmitted to the user device via any of the communication channels described above. In some embodiments, the prompt may be a mobile device notification, a window, a webpage, a web form, a pop-up window, and/or a new Internet browser tab. In particular embodiments, the prompt includes information about the requested interaction from the third party and any additional information that accompanied the request received from the third party. In various embodiments, the prompt includes a selectable option or response that a user may select either to approve the interaction/transaction or to deny the interaction. For example, the prompt may include a selectable response of either an affirmative response (complete the requested interaction) or a negative response (do not complete the requested interaction). In some embodiments, the prompt may simply ask the user to “approve” the interaction with a “one-click” selectable navigation link or CTA button styled link. In various embodiments, the prompt may include one or more editable sections, allowing the user to make any necessary changes. For example, if the user does not agree with the amount requested by the third party, or if the user wants to change the date that payment is sent to the third party, those changes may be made directly within the prompt without requiring the user to navigate to a different webpage, etc.

The next step, as represented by block 330, is to receive, via the user interaction interface, a user confirmation that the interaction needs to be completed. In some embodiments, the user may choose not to select the “approve” link, thereby ending the process. In other embodiments, where the user confirms that the interaction needs to be completed, the next step, as represented by block 335, is for the system to complete the requested interaction.

In practice, for example, the system may receive a notice of a bill from a mortgage company associated with the user that has a due date on the 1^{st} of the month. The system will then establish communication with the user through the user's device and display the user interaction interface on the user device. Once displayed, the user may enter identifying information that the system will then use to verify the authenticity of the user and the identifying information. Provided the user is an authorized user and the identifying information is determined to be authentic, the system will transmit a prompt or notification to the user regarding the bill received from the mortgage company. The prompt preferably includes an approval link or button that the user may select, thereby allowing the system to complete the process by sending payment to the mortgage company, as requested.

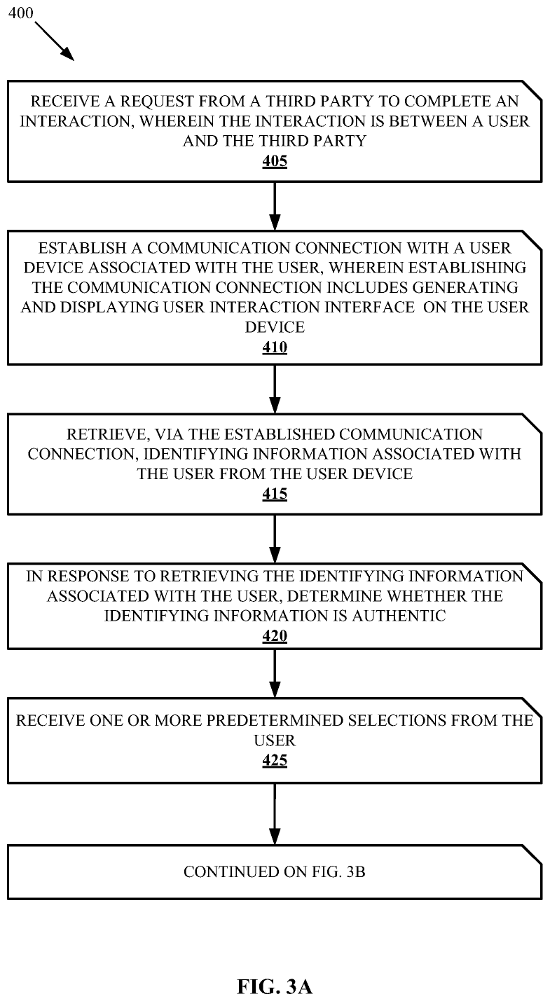

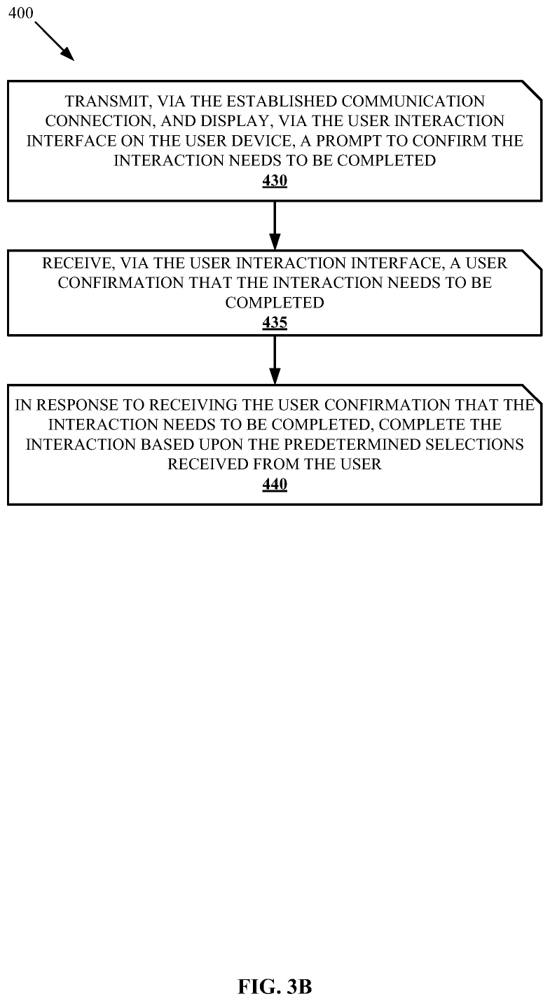

FIGS. 3A-3B depict a flow chart representing a system and method 400, according to at least one embodiment, for completing an interaction in response to a prompt having prefilled data based on predetermined selections received from the user or the third party, or interaction preferences determined by the system. Similar to the method described with reference to FIGS. 2A-2B, the method 400 is performed by a system that includes at least one processor, a communication interface communicatively coupled to the at least one processor and configured to communicate over at least one network with one or more additional sets of processors, and a memory device storing executable code, that when executed, causes the processor to perform a series of events. Many features of the system that performs method 400 are the same or similar to those features recited above with regard to FIGS. 2A-2B. Thus, for purposes of ease of understanding and clarity, only certain features will be discussed to highlight the differences in the systems and methods of the embodiment shown in FIGS. 2A-2B as compared to the embodiment shown in FIGS. 3A-3B.

The first step, as represented by block 405, is to receive a request from a third party to complete an interaction. The requested interaction is an interaction or transaction between the third party and a user having one or more accounts with the owner of the system, such as a bank or other financial institute.

The next step, as represented by block 410, is to establish a communication connection with a user device associated with the user, wherein establishing the communication connection includes generating and displaying a user interaction interface on the user device. the user interaction interface may be any suitable graphical user interface (GUI) created for the system.

The next step, as represented by block 415, is to retrieve, via the established communication connection, identifying information associated with the user from the user device. At block 420, in response to retrieving the identifying information associated with the user, the system determines whether the identifying information is authentic.

The next step, as represented by block 425, is to receive one or more predetermined selections from the user. Although shown as occurring after the request is received from the third party, this step may be completed at any point in time. For example, the system may store the predetermined selections for later use when a requested interaction is received. In example embodiments, the selections are manually selected by the user. In other embodiments, the selections or interaction preferences associated with the user are ascertained or determined by the system based on prior interactions and transactions completed by the user. For example, if the user always pays a particular bill on a particular date from a particular account, the system will use these events as the one or more predetermined selections for the user for the requested interaction from the third party. Thus, the one or more predetermined selections include a pay-from account, a pay-to account, a date to pay, and an amount to pay. In alternate embodiments, the one or more predetermined selections, or prefilled data, may be based on the request received from the third party. For example, the request may include the prefilled data for the user including a date, an amount for payment, and the name of the third party.

The next step, as represented by block 430, is to transmit, via the established communication connection, and display, via the user interaction interface on the user device, a prompt to confirm that the interaction needs to be completed.

The next step, as represented by block 435, is to receive, via the user interaction interface, a user confirmation that the interaction needs to be completed. At block 440, in response to receiving the user confirmation that the interaction needs to be completed, the system completes the interaction based on the one or more predetermined selections received from the user, received from the third party, or determined by the system based on the user's prior interactions. Similar to method 300, the system may allow the user to edit any prefilled data prior to completing the requested interaction. In some embodiments, the system may receive an indication from the user device to alter the one or more interaction preferences associated with the user and store and replace the original interaction preferences with the altered interaction preferences.

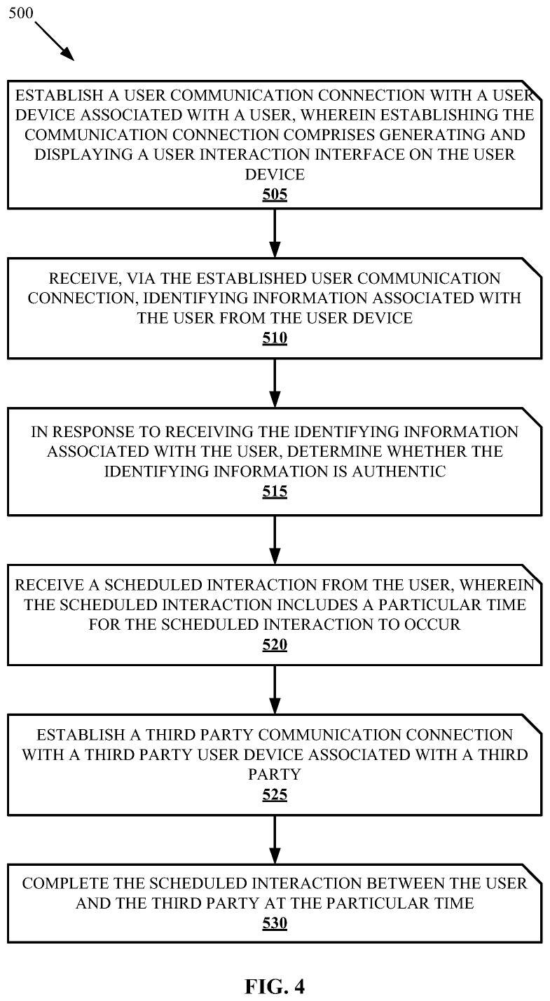

FIG. 4 is a flow chart representing a system and method 500, according to at least one embodiment, for completing an interaction at a particular and specific time. Similar to the method described with reference to FIGS. 2A-2B, the method 500 is performed by a system that includes at least one processor, a communication interface communicatively coupled to the at least one processor and configured to communicate over at least one network with one or more additional sets of processors, and a memory device storing executable code, that when executed, causes the processor to perform a series of events. Many features of the system that performs method 500 are the same or similar to those features recited above with regard to FIGS. 2A-2B. Thus, for purposes of ease of understanding and clarity, only certain features will be discussed to highlight the differences in the systems and methods of the embodiment shown in FIGS. 2A-2B as compared to the embodiment shown in FIG. 4.

The first step, as represented by block 505, is to establish a user communication connection with a user device associated with the user, wherein establishing the communication connection includes generating and displaying a user interaction interface on the user device.

The next step, as represented by block 510, is to receive, via the established user communication connection, identifying information associated with the user from the user device. At step 515, in response to receiving the identifying information associated with the user, the system determines whether the identifying information is authentic.

The next step, as represented by block 520 is to receive a scheduled interaction from the user via the user device, wherein the scheduled interaction includes a particular time for the scheduled interaction to occur. For example, a small business may want to wait until the end of the day, once they have made all of their sales for the day, to send a payment to a vendor or other entity. In a further example, a user may want to schedule a transfer of funds from their account to their child's account on the child's birthday and at the time the child was born.

Similar to the requested interactions discussed above, the scheduled interaction may include a bill payment, an ACH transaction, or an electronic fund transfer. Additionally, the scheduled interaction includes a pay-from account, a pay-to account, a date to pay, and an amount to pay. The scheduled interaction may be received from the user at any point in time prior to the particular time the interaction is scheduled to be completed. For example, the scheduled interaction may be set to occur in a year based on the user's failure to remember to give a family member a birthday present. The scheduled interaction would prevent the user from missing the family member's birthday again! Thus, the scheduled interaction may be scheduled for a particular time at any point in time between when the interaction is received by the system and when the interaction is scheduled to be completed.

The next step, as represented by block 525, is to establish a third party communication connection with a third party user device associated with a third party. In example embodiments, the third party will be the recipient of the scheduled interaction from the user.

The next step, as represented by block 530, is to complete the scheduled interaction between the user and the third party at the indicated particular time. In example embodiments, the scheduled interaction is a real-time payment from the user to the third party at the specified time. For example, the user may indicate that they want to send a payment to a third party at 11:59 PM on a particular day. In response to completing the scheduled interaction between the user and the third party at the particular time, in certain embodiments, the system may receive, via the established third party communication connection, confirmation that the scheduled interaction has been completed.

Particular embodiments and features have been described with reference to the drawings. It is to be understood that these descriptions are not limited to any single embodiment or any particular set of features. Similar embodiments and features may arise or modifications and additions may be made without departing from the scope of these descriptions and the spirit of the appended claims.

What is claimed is:

1. A system for completing an interaction at a particular time, the system comprising:
at least one processor;
a communication interface communicatively coupled to the at least one processor and configured to communicate over at least one network with one or more additional sets of processors; and
a memory device storing executable code that, when executed, causes the processor to:
establish a user communication connection with a user device associated with a user, wherein establishing the communication connection comprises generating and displaying a user interaction interface on the user device;
receive, via the established user communication connection, identifying information associated with the user from the user device;
in response to receiving the identifying information associated with the user, determine whether the identifying information is authentic;
receive a scheduled interaction from the user, wherein the scheduled interaction includes a particular time for the scheduled interaction to occur;
establish a third party communication connection with a third party user device associated with a third party;
complete the scheduled interaction between the user and the third party at the particular time.

2. The system of claim 1, wherein the scheduled interaction comprises a real-time payment from the user to the third party at the particular time.

3. The system of claim 1, wherein the scheduled interaction comprises at least one of bill pay, ACH transaction, and electronic fund transfer.

4. The system of claim 1, wherein the scheduled interaction comprises at least one of a pay-from account, a pay-to account, a date to pay, and an amount to pay.

5. The system of claim 1, wherein when determining whether the identifying information is authentic, the executable code, when executed, further causes the processor to:
generate a unique code;
transmit the unique code to at least one of the user device associated with the user and a mobile device associated with the user;
display the unique code on the at least one of the user device associated with the user and the mobile device associated with the user;
receive from the user device the unique code; and
in response to receiving the unique code from the user device, determine that the identifying information is authentic.

6. The system of claim 1, wherein the executable code, when executed, further causes the processor to:
receive, via the established third party communication connection, confirmation that the scheduled interaction has been completed.

7. The system of claim 1, wherein the identifying information associated with the user comprises at least one of biometric authentication credentials, a personal identification number, a password, and a two-step verification protocol comprising accessing a passcode generated by a one-time password algorithm.

8. A method for completing an interaction at a specified time, the method comprising:
establishing a user communication connection with a user device associated with a user, wherein establishing the communication connection comprises generating and displaying a user interaction interface on the user device;
receiving, via the established user communication connection, identifying information associated with the user from the user device;
in response to receiving the identifying information associated with the user, determining whether the identifying information is authentic;
receiving a scheduled interaction from a user, wherein the scheduled interaction includes a specified time for the scheduled interaction to occur;
establishing a third party communication connection with a third party user device associated with a third party;
completing the scheduled interaction between the user and the third party at the specified time.

9. The method of claim 8, wherein the method further comprises:
generating a unique code;
transmitting the unique code to at least one of the user device associated with the user and a mobile device associated with the user;
displaying the unique code on the at least one of the user device associated with the user and the mobile device associated with the user;
receiving from the user device the unique code; and
in response to receiving the unique code from the user device, determining that the identifying information is authentic.

10. The method of claim 8, wherein the method further comprises:
receiving, via the established third party communication connection, confirmation that the scheduled interaction has been completed.

11. The method of claim 8, wherein the identifying information associated with the user comprises at least one of biometric authentication credentials, a personal identification number, a password, and a two-step verification protocol comprising accessing a passcode generated by a one-time password algorithm.

12. A system for completing an interaction at a preselected time, the system comprising:
at least one processor;
a communication interface communicatively coupled to the at least one processor and configured to communicate over at least one network with one or more additional sets of processors; and
a memory device storing executable code that, when executed, causes the processor to:
establish a user communication connection with a user device associated with a user, wherein establishing the user communication connection comprises generating and displaying a user interaction interface on the user device;
receive, via the established user communication connection, identifying information associated with the user from the user device;
in response to receiving the identifying information associated with the user, determine whether the identifying information is authentic;
receive at a first time a scheduled interaction from the user, wherein the scheduled interaction includes an indication for the scheduled interaction to occur at a second time;
establish a third party communication connection with a third party user device associated with a third party;
complete the scheduled interaction between the user and the third party at the second time.

13. The system of claim 12, wherein the first time chronologically precedes the second time.

14. The system of claim 13, wherein the first time chronologically precedes the second time by about 1 hour.

15. The system of claim 12, wherein the identifying information associated with the user comprises at least one of biometric authentication credentials, a personal identification number, a password, and a two-step verification protocol comprising accessing a passcode generated by a one-time password algorithm.

16. The system of claim 12, wherein when determining whether the identifying information is authentic, the executable code, when executed, further causes the processor to:
generate a unique code;
transmit the unique code to at least one of the user device associated with the user and a mobile device associated with the user;
display the unique code on the at least one of the user device associated with the user and the mobile device associated with the user;
receive from the user device the unique code; and
in response to receiving the unique code from the user device, determine that the identifying information is authentic.

17. The system of claim 12, wherein the first time and the second time are separated by between about 6 hours and about 730 hours.

18. The system of claim 12, wherein the executable code, when executed, further causes the processor to:
receive, via the established third party communication connection, confirmation that the scheduled interaction has been completed.

19. The system of claim 12, wherein the scheduled interaction comprises at least one of bill pay, ACH transaction, and electronic fund transfer.

20. The system of claim 12, wherein the scheduled interaction comprises at least one of a pay-from account associated with the user, a pay-to account associated with the third party, a date to pay, and an amount to pay.
